(19) United States
(12) Patent Application Publication
(10) Pub. No.: US 2008/0124368 A1
(43) Pub. Date: May 29, 2008

(54) Composition

(76) Inventor: Shantha Sarangapani, Walpole, MA (US)

Correspondence Address: RICHARD D. FUERLE, 1711 W. RIVER RD., GRAND ISLAND, NY, 14072, US

(21) Appl. No.: 12/005,109

(22) Filed: Dec. 26, 2007

Related U.S. Application Data
(63) Continuation-in-part of application No. 11/069,705, filed on Mar. 1, 2005, now abandoned.
Application No. 11/069,705 is a continuation-in-part of application No. 10/925,631, filed on Aug. 25, 2004.
(60) Provisional application No. 60/877,115, filed on Dec. 26, 2006.

(51) Int. Cl. C09D 5/16; A01N 25/00

(52) U.S. Cl. 424/405; 523/122

(57) ABSTRACT

An antimicrobial composition is formed from about 5 to about 25 wt % of an antimicrobial formulation and about 75 to about 95 wt % of a polyurethane resin or polyurethane hybrids, copolymers, or mixtures with other polymers such as polyesters, nitrites, PVC, and synthetic rubber latexes. The antimicrobial formulation is formed from about 60 to about 90 wt % of an antimicrobial material, about 1 to about 30 wt % calcium chelator, about 0.001 to about 2 wt % color and appearance enhancing pigments, about 0.001 to about 2 wt % of surfactants, and about 0.5 to about 10 wt % lubricant. The polyurethane resin may be a nonaqueous or aqueous latex dispersion or a prepolymer that polymerizes when exposed to moisture. An antimicrobial coating may be formed on the surface of an article by applying an antimicrobial composition to the article; if a polyurethane prepolymer is used, the composition is exposed to moisture and if an aqueous or nonaqueous dispersion is used, the water or solvent is evaporated. A coating may also be formed by making a mixture of the antimicrobial formulation and a resin and molding, overmolding, or extruding the article from the compounded mixture.

### CROSS REFERENCE TO RELATED APPLICATIONS

This application is a continuation-in-part application of patent application Ser. No. 11/069,705, filed Mar. 1, 2005, which is in turn a continuation-in-part application of patent application Ser. No. 10/925,631, filed Aug. 25, 2004. A provisional application was filed on Dec. 26, 2006 reference number 60/877,115

### BACKGROUND OF THE INVENTION

This invention relates to antimicrobial formulations that comprise an antimicrobial material, a calcium chelator, a pigment, surfactant, and a lubricant. The antimicrobial formulation can be mixed with silicone (“silicone resin”), polyurethane resins and blends, copolymers or hybrids thereof to create adhesive formulations, coating formulations, or molded or extrudable materials; they, in turn, can be made into articles such as polymer based medical devices, including metal and metal alloy based devices, and into nano, micropourous materials and woven or non-woven fabrics.

In particular, the invention relates to antimicrobial formulations that can be blended with a resin such as polyurethane (which may include prepolymers, copolymers of polyurethanes such as silicone-polyurethanes, or acrylic or polyester polyurethanes, solvent and water borne polyurethanes, polyurethane acrylates), polyesters, polycarbonates, acrylates, styrene-butadiene rubbers, synthetic and natural rubber, PVC (polyvinyl chloride), water based nitriles, synthetic rubber dispersions, and emulsions

Silicone and polyurethanes, or blends and copolymers of polyurethanes, are soft, highly flexible and non-toxic materials extensively used for several types of medical devices, including catheters, stents, Foley catheters used for incontinence, other urological catheters, gastrostomy tubes, feeding tubes, and certain consumer products. Medical polymeric and metallic parts, like other materials, are susceptible to bacterial adherence, which leads to the formation of biofilms and the encrustation of calcium deposits when used in contact with body fluids such as urine, blood, bile, etc. The presence of bacteria on medical articles can result in infections and the spreading of diseases.

Microporous or nanoporous materials are also used in the fabric industry along with non-woven and woven fabrics. Examples include air or water filters, surgical and breathing masks, and medical fabrics.

Short term and long term delivery of active ingredients at a desirable and effective concentration from medical and other devices and materials is an important criteria for performance over extended periods of time. In addition to the release of antimicrobial substances, the application could be the release of drugs, fragrances, lubricants, toxin neutralizers, chemical neutralizers, or any active ingredient for the specific application.

With medical devices that contact body fluids, adsorbed body fluid components such as proteins, blood ingredients, and electrolytes, affect the sustained delivery of active materials. This is due to the “blocking” effect of adsorption as well as chemical interactions, such as precipitate formation, etc. The nature of the polymer or the plastic used as the matrix as well as the formulation chemistry, the diffusional properties of the active components, and the nature of immediate environment, combine to create a complex pattern that controls the release of the active components.

Under dry conditions the coatings should still maintain a high moisture content at their surfaces, thereby plasticizing the coatings and allowing the active ingredients to migrate to the surface. The challenges are less for “dry” applications” (in contrast to surfaces that are constantly wet, which may elute the active components more quickly), such as fabrics and gloves; however, an effective moisture content needs to be maintained on the surface to facilitate the actives to diffuse and migrate to the surface.

The present invention is directed to an antimicrobial coating on various materials, such as natural latex, polyurethanes, polyvinyl chloride, and silicones. In a preferred method of the coating, an active powder formulation at a particular weight percentage are dispersed homogeneously in a solvent containing the dissolved polymer along with lubricants, surfactants, coloring and/or special effect pigments. The mixture is adjusted to a desirable viscosity for applying as a coating directly on an article. In another embodiment, the polymer based antimicrobial composition is used as an adhesive or a coating for microporous materials, fabrics, gloves, etc.

In a preferred method of manufacturing the non-woven or woven fabric, a coating is bonded to fabric fibers or is applied as a continuous or discontinuous film, depending on the need for air permeability or moisture permeability. The antimicrobial agent is thereby on the surface of the fabric bonded to the coating material and is available to provide continuous antimicrobial action relative to fluids and body parts that come into contact with it.

The major advantages of the current invention that over the prior art are:

(1) The sustained delivery of active components such antimicrobials at an effective level;

(2) The sustained presence of a lubricant on the surface that discourages bacterial and protein adhesion;

(3) The ability of the hydrophilic polyurethane-based formulation of this invention to directly adhere to materials such as latex, polyether urea, polyurethanes consisting of aliphatic “hard segments” and different proportions of polyethylene glycol (PEG) and polytetramethylene glycol (PTMG) “soft segments,” where the proportions of PEG and PTMG can be varied during polymer synthesis to provide the desired water uptake and water permeation properties. Generally, higher water uptake and higher permeability materials comprise a higher proportion of PEG; examples include “Tecophilic” resins and “Tecogel,” sold by Lubrizol Corp (formerly Noveon).

(4) The ability of the coated or adhesively bonded materials of this invention to provide an active and passive barrier to microorganisms.

(5) The increased processability of the plastic film, membrane or article after blending and compounding the active formulations encapsulated or microencapsulated in the hydrophilic polymer matrix.

### SUMMARY OF THE INVENTION

The antimicrobial compositions of this invention can be used as coatings (in the form of dispersions), as adhesives (as a discontinuous dot-matrix layer or as a continuous layer between two surfaces), or as fabricated articles (by solvent casting, extrusion, molding, and after compounding)

Surfaces, such as natural latex rubber or plastics or metals, can be difficult to coat with polymers, but this invention has overcome that problem. A coating on the surface of an article is achieved either by coating the article with a composition containing a polyurethane resin or by compounding an antimicrobial formulation with a polyurethane resin that is molded, overmolded, or extruded into the article. The coating becomes integrated with the surface of the article and does not delaminate, swell, or separate. Due to the slow release of the antimicrobial material, such surfaces show a consistent and continuous antimicrobial activity when challenged with microorganisms.

The principal object of the present invention is to produce an antimicrobial composition that is useful for coating medical articles, or can be incorporated into medical articles, in order to prevent the formation of biofilms and encrusted deposits thereon.

Another object of the present invention is to provide a coatable composition that includes a polyurethane resin, a polyurethane prepolymer, a copolymer of a polyurethane with silicone, an acrylic, a polyester, a solvent or water-borne polyurethane, an acrylate, or a polymer such as a polyester, polyvinyl chloride (PVC), a water-based nitrile, or a synthetic rubber dispersion or emulsion.

Yet other objects of this invention are to provide coatable compositions for urinary catheters, urological devices, feed tubes, gastric buttons, and other types of devices that are made of medical polymers or other materials, such as metal and plastic stents and implants, and to enhance the lubricity of the surface of a medical article by releasing a lubricious, non-toxic compound from a coating of the composition.

Another object of this invention is to provide certain novel potent antiviral formulations that are active against human immunodeficiency virus (HIV). Such formulations could be used by themselves or in combination with the lubricants and antimicrobial formulations described in this application.

Yet another object of this invention is to provide antimicrobial polyurethane coatings for silica particles, surface-modified silica-based ceramics, textile finishes, adhesives made of urethane, acrylate polymers, filament wound water filters, cartridges, storage tanks, sealing caps, glove linings, gloves, and fabric coatings such as water repellent finishes.

Another object of this invention is to provide a chemical formulation for direct blending with polyurethane resins for direct extrusion or overmolding onto an article.

### DESCRIPTION OF THE PREFERRED EMBODIMENTS

### The Antimicrobial Composition

The antimicrobial composition of this invention has two parts, an antimicrobial formula with four components and a polyurethane resin.

### Part I—The Antimicrobial Formulation

The antimicrobial formulation has five components; an antimicrobial material, a calcium chelator, a pigment, a lubricant, and a surfactant. A preferred antimicrobial formulation is about 10 to about 16 wt % silver citrate, about 5 to about 7 0 wt % nanosize (i.e., less than about 100 nanometers) silver powder (about 2.5% of the weight of silver being copper nanopowder), about 5 to about 15 wt % EDTA or a vinyl phosphonic acid or hydroxy ethyl phosphonic acid, about 20 to about 40 wt % propyl paraben, and about 10 to about 22 wt % citric acid.

The antimicrobial formulation of this invention may be prepared by finely blending the above-described components; blending may be performed, for example, in an industrial blender.

### The Antimicrobial Material

The purpose of the antimicrobial material is to kill bacteria, yeasts, and molds. Examples of suitable antimicrobial materials include nanosize particles of metallic silver or an alloy of silver containing about 2.5 wt % copper (hereinafter referred to as “silver-copper”), salts such as silver citrate, silver acetate, silver benzoate, bismuth pyrithione, zinc pyrithione, zinc percarbonates, zinc perborates, bismuth salts, various food preservatives such as methyl, ethyl, propyl, butyl, and octyl benzoic acid esters (generally referred to as parabens), citric acid, sodium percarbonate, and urea-peroxides. For short term applications, sodium percarbonate, sodium perborate, or urea-peroxide can be used with resins in non-aqueous solvents and coated. Percarbonates and urea peroxide are activated by water and evolve hydrogen peroxide, which is a potent biocide. The preferred antimicrobial materials are silver, partially water soluble compounds of silver, silver pyrithione, zinc pyrithione, bismuth pyrithione, parabenzoic acid esters, and mixtures thereof.

Silver particles having a particle size of about 1 to about 100 nm are believed to slowly release silver ions, Ag+, which are antimicrobial. Silver and silver salts, such as silver citrate, are especially preferred, because they are very effective and safe bactericides due to their rapid release of silver ions. Propyl paraben, butyl paraben, and octyl paraben are the preferred antimicrobial materials for yeasts and molds due to their low solubility in water. Other antifungals, such as zinc based or polyene antifungals, the imidazole family, triazole, allylamines, echinocandins, and natural oils such as tea tree, coconut oil, and the like, may be substituted for the parabens. About 65 to about 91 wt % of the antimicrobial formulation may be the antimicrobial material; less is ineffective. Preferably, about 40 to about 65 wt % of the antimicrobial material is used in the formulation of which about 15 to about 25 wt % is silver, silver-copper, a partially water soluble silver salt, or a mixture thereof, and about 25 to about 40 wt % is antifungal compounds. The antimicrobial material slowly leaches from the formulation, keeping the coated surface free of live bacteria, yeasts, and molds.

### The Calcium Chelator

The calcium chelator prevents deposits of calcium and/or magnesium from forming, which may impede the flow of urine. Examples of suitable chelators include ethylenediamine tetraacetic acid (EDTA), citric acid, hydroxyethylidene phosphonic acid, polyvinylphosphoric acid, polyvinylsulfonate, acrylic acid, and aminophosphonic acid. The preferred chelators are citric acid and EDTA because of their ability to solubilize silver and form complexes with calcium ions. About 1 to about 55 wt % (based on the weight of the antimicrobial formulation) may be calcium chelator. More is undesirable because of its acidity and less is undesirable because the efficacy of the long term release may be reduced. Preferably, the chelator is about 20 to about 25 wt % citric acid and about 20 to about 25 wt % EDTA. Applications where encrustation or protein adsorption are not issues do not particularly require the use of calcium chelators and lubricants.

### The Pigment

The purpose of the pigment is for coloring, as the silver imparts a dark grayish color, which may not be desirable; the addition of the pigment imparts a bluish gray shade. Copper phthalocyanine (pigment blue) is the preferred pigment because it is believed to also have a bacteriostatic effect and is used in surgical sutures. FDA approved other coloring additives and appearance enhancing pigments commonly used by the cosmetics or medical industries may also be used to the level of about 0.001 to about 3 wt %. An example of a suitable pigment is micronized titania-coated mica such as that sold by Eckhart Industries. About 0.001 to about 0.25 wt % (based on the weight of the antimicrobial formulation) may be coloring pigment. More is undesirable because of the high intensity in color and the blocking effect of the large pigment molecules, and less is undesirable because the benefit of the color is lost (i.e., the color is visually not pleasing). Preferably, about 0.1 to about 0.25 wt % of the coloring pigment is used with about 1 to about 3 wt % of the color enhancing titania-coated mica particles.

### The Lubricant

The purpose of the lubricant is to make the surface lubricious, which is advantageous because it helps to prevent bacteria from adhering to the filter. Examples of suitable lubricants include polyethylene oxide, polyacrylic acid, polyvinylpyrrolidone, polyvinyl alcohol, polyethylene, propylene glycols, and derivatives thereof. The preferred lubricant is polyethylene oxide (PEO) because it discourages cell adhesion and can be incorporated into the antimicrobial formulation. About 4 to about 12 wt % (based on polyurethane resin solids in the formulation) is lubricant. More is undesirable because of it may make processing more difficult and less is undesirable because the surface may not be sufficiently lubricious. Preferably, about 5 to about 10 wt % lubricant is used.

### The Surfactant

The surfactant helps to make the polar materials compatible with the organic solvent and may also enhance the antimicrobial properties of the formulation. Preferred surfactants include polyoxyethylene, sorbitan, or sorbitol derivatives, for example, “Tween 60” (from Sigma-Adrich) and “Pluronic™” types (the general class is called polaxamers, that are block polymers of ethylene oxide, propylene glycol, ethylene glycol, and propylene oxide in different combinations (available from Spectrum Chemical) or another biocompatible natural and synthetic surfactant such as lecithins (available from Spectrum Chemical) or bile surfactants. About 0.01 to about 2.0 wt % of the antimicrobial formulation is surfactant.

### PART II—The Polyurethane Resin

The polyurethane resin may be in the form of extrudable solid resin particles, a non-aqueous solvent-dispersed polymer, a prepolymer, or an aqueous or non-aqueous polyurethane dispersion. The amount of polyurethane resin in the antimicrobial composition may be about 60 to about 95 wt %; less may not produce an adequate coating and more may produce a coating with an inadequate amount of antibacterial formulation in it. The preferred amount is about 70 to about 95 wt %. Mixtures of a polyurethane resin with another resin may also be used.

### Polyurethane Prepolymers

The prepolymers, i.e., incompletely cured polymers, are normally viscous liquids. Examples of prepolymers include the “Hypol” series, sold by Dow Chemical, and the “Desmodur” series, sold by Bayer Company. The polyurethane prepolymer “Hypol 2002,” a polyurethane with free isocyanate groups, sold by Dow Chemical Corp., has an equivalent weight of 633/NCO; every gram of “Hypol 2002” has 1.58 millimoles of the isocyanate group, —NCO, which reacts with water and completes the cure. In addition, the “Hypol” family of prepolymers are characterized by a high affinity for water (hydrophilicity), which makes the cured coating permeable to water; that is important for slow release applications of this invention. In the “Hypol 2002” curing reaction, the isocyanate groups come from incompletely-reacted toluene diisocyanate monomers. Other polyurethane prepolymers that contain dihydo or methylene diisocyanates, isophorone diisocyanate, or tetra methyxylinyl diisocyante may also be used.

The free isocyanate groups in the prepolymers react with moisture and form a fully polymerized polyurethane resin. A non-foaming resin, which produces a smooth surface, is made if the water is introduced by exposing the prepolymer to moisture. If the water is mixed into the prepolymer, a foam is produced; slowly curing in the presence of atmospheric moisture does not form a foam, but direct mixing of liquid water with the prepolymer does. Generally, smooth surfaces are desirable, but a foam may be used for some applications, such as wound dressings, glove liners, gloves, protective clothing, filtration liners, and even for water purification as a slow release medium. The prepolymers are about 25 to about 89 wt % solutions dissolved in a non-aqueous solvent, such as methyl ethyl ketone, acetone, tetrahydrofuran, or mixtures thereof.

### Polyurethane Dispersions

The water based polyurethane dispersions are latex particles that are cationic or anionic stabilized by the charge repulsion among the particles. They are fully polymerized and do not have free isocyanate groups. They have built-in cross-linking mechanisms that cure the polymer when the water is evaporated, forming films or coatings. The preferred polyurethane dispersion is a high water uptake, medical grade, aliphatic, polyether polyurethane manufactured by Noveon, Inc., Woburn, Mass., (now owned by Lubrizol Corp.), sold as “Tecophilic™ SP” (solution process grade) and as “Tecogel™”, hereinafter referred to as “Tecophilic” resins.” “Tecogel” polyurethane, sold by Noveon, has high hydrophilicity, and may also be used as a solvent-based dispersion instead of the prepolymer for coating polyurethane based devices. For extrusion of the antimicrobial formulation, medical grade polyurethane resins, such as the high water uptake family of polyurethane materials, sold by Lubrizol, may be used. Related polyurethane dispersions are also sold by Cardiotech and Polymer Technology Group in CA. Other examples include the Cytec products, sold by Cytec Industries, called “Cydrothane,” and also products sold by Bayer. These products are mainly used for automotive and building applications. Some grades, however, such as from Cytec Industries, may be suitable for medical and glove coating applications.

### Adhesion Promoter

The water-borne dispersions are used with about 0.1 to about 3 wt % (based on antimicrobial composition weight) of an adhesion promoter; the preferred amount of adhesion promoter is about 1 to about 2 wt %. An adhesion promoter permanently bonds the coating formulation to a surface via a cross-linking mechanism (adhesive bonding). Cross-linking also happens within the resin itself (cohesive bonding), which improves film properties and gives better heat stability and solvent and water resistances. Adhesion promoters are basically chelating agents or thin inorganic oxide formers, such that surface roughness or tethering chemistry between the coating and the surface is established.

### Optional Components

Optional components may also be included in the antimicrobial formulation. For example, it is preferable to include about 0.5 to about 4 wt % of nanosize (20 to 40 nm) high surface area titanium dioxide as a support for loading of the antimicrobial formulation and also to lighten the color. Zinc pyrithione or bismuth pyrithione are optional antimicrobial materials that may be included at very small percentages such as about 0.1 to about 0.5 wt % (based on the polymer in the formulation).

### Coatings

The antimicrobial coating composition of this invention may be used to coat the surfaces of articles to retard the growth of microbes thereon. Examples of articles that may be coated include silica particles, surface-modified silica-based ceramics, textile finishes, filament-wound water filters, cartridges, storage tanks, sealing caps, glove linings, gloves, and fabric coatings such as water repellent finishes. While any surface may be coated with the composition, the composition is preferably used to coat the surfaces of medical devices that are prone to infection, such as catheters, stents, Foley catheters, gastrostomy tubes, feeding tubes, silicone-coated latex type surfaces, silicone valves, balloons, septa, silicone parts used in various medical pumps, tubes, and earplugs, and as a textile finish for linings for hospital beds, window shades, and curtains. These articles may include materials such as plastics, metals, glass, and ceramics. Preferably, they are made of a polymeric material (a plastic), such as silicone, silicone coated plastics, and polyurethanes. The preferred material is silicone because the coating adheres better to silicone.

To coat a surface with the antimicrobial material, the surface is cleaned, if necessary, which may be done using, for example, a water-based detergent then drying thoroughly, or with an organic solvent such as ethanol, then drying and wiping the surface with hexane. The composition may be applied to the surface by any suitable technique. The following are examples of coating techniques that may be used, depending on the substrates:

Dip/immersion coating

Dip molding

Kiss coating (lick roll)

Knife coating (over air, roll or rubber sleeve)

Rotogravure coating

Spray coating

Other methods such as bar coating or rotary screen printing

### The preferred methods are dip coating and dip molding using a mandrel in the same shape as the article.

The solution or dispersion may have to be applied with adjusted viscosities once or several times to the surface in order to achieve the desired thickness for the coating. The thickness of the coating should be about 0.5 to about 2 mils as thinner coatings may be less effective and thicker coatings may not be necessary. A preferred thickness is about 1 to about 2 mils.

After each layer of coating is applied, the surface is dried. This may be accomplished, for example, by air drying or by warming the surface in an oven. The composition is preferably dried at room temperature followed by drying at about 50 to about 60° C. for about 3 to about 4 hours. Articles with balloons made of silicone, such as Foley silicone catheters, may be easily coated with the composition of this invention and were found to pass both the ASTM and the European standard test for balloon expansion in Foley catheters and the burst strength tests.

To form an article by dip molding, a mandrel in the shape of the article is heated, dipped into a tank holding an antimicrobial composition, and removed from the tank. The viscosity of the solution depends on its solids content, which can be increased by adding more solids or decreased by adding more solvent until the desired viscosity is attained. After dipping, the thin coating of the composition that remains on the surface of the mandrel is allowed to dry and/or cure, then is stripped off as a finished product. Multiple dipping steps may be used to increase the thickness of the coating and curing time, temperature, and speed of immersion may be adjusted to control the properties of the resulting article. Gloves, balloons, and other articles may be made by this process.

### Description of Hydrophilic, High Water Uptake, Polyurethane Coatings for Natural Latex

Step (1). The antimicrobial formulation from Example 1 at, preferably, about 5 to about 10 wt % with respect to the polymer weight, may be dispersed in a solvent such as methyl ethyl ketone (MEK) in the presence of a surfactant such as “Tween 60” (Sigma-Adrich).

Step (2). In another container, a yellow coloring dye and appearance-enhancing pigment such as “soft silver” is dispersed in MEK at a level of about 1 to about 3 wt %. Soft silver (sold by Eckhart) is a cosmetic pigment that imparts a glittery silver-like appearance to the formulation; it is actually mica particles coated with titania and is biocompatible.

Step (3). The lubricant PEO (polyethylene oxide) is dispersed in MEK, preferably at a level of about 4 to about 8 wt %, in the presence of “Tween 60” and simethicone in a weight ratio of about 1:5. (Simethicone is a mixture of polydimethylsiloxane and silica gel and is normally used as an antifoaming agent; it is available from Spectrum Chemicals, NJ.) This mixture mat be blended with a solution of a solution grade “Tecophilic” resin dissolved in tetrahydrofuran (THF), about 6% w/w, maintained at about 35° C. for about 30 minutes.

Step (4). The products of Steps (2) and (3) are mixed together well followed by the further addition of the product of Step (1). An optional addition of polyethylene glycol to about 0.5 to about 2 wt % with respect to total solids may be done at this point for fast antimicrobial release applications. The formulation can now be coated directly latex Foley catheters that have no other coatings on them. The latex surface can be pre-cleaned by soaking it in a mixture of 1:1:1 toluene, water and isopropyl alcohol, after cleaning with soap water and drying.

The coating formulation was heated to about 30 to about 40° C. prior to coating and was maintained at about 35° C. during coating. Dip-coating was used and the formula was sucked into the lumen of the catheter to uniformly coat the internal surface. After one dip the catheter was dried and recoated. Alternatively, a hypotube may be used for a controlled fill of the internal lumen. The coated tubes were dried at about 50-60° C. for 2 hours. Highly adherent and smooth coatings were produced. Surprisingly, there was excellent adhesion of the above polyurethane coating composition to pre-cleaned latex Foley catheter.

### Incorporation of the Formulation in a Dry Form into Plastics

The antimicrobial formulation of this invention may also be incorporated into an article, so that it will gradually leach to the surface of the article and form a coating on the surface that retards the growth of microbes thereon. A solid resin of polyurethane, polyesters or medical grade polymeric materials, or liquid or solid silicone is compounded with the antimicrobial composition, followed by extrusion. Materials in which the formulation may be incorporated include silicone resins, liquid silicone, polyurethanes, polyvinyl chloride (PVC), and silicone-polyurethane blends. The preferred material is liquid silicone because of its ability to form conformal molded shapes and also to conformal overmolded parts. This also avoids the need to use a solvent.

To incorporate the formulation into a material, the formulation is mixed with the material to produce a homogeneous mixture. The mixture may contain about 5 to about 20 wt % of the formulation; less formulation may not be sufficiently effective in retarding the growth of microbes and more formulation may adversely affect the properties of the material. Preferably, the formulation is about 5 to about 12 wt % of the mixture.

The mixture is then formed into a desired shape and is hardened. The article may be shaped by molding, overmolding, extrusion, or another process. Depending upon the resin used, hardening may occur as a result of exposure of the material to air, heat, moisture, or as the result of a chemical reaction that began when the resin was prepared.

Incorporation of the antimicrobial formulation into an article is preferred to coating a surface with the composition as it is a less time-consuming procedure.

### Incorporation into Polyurethane

Extrudable grades of the polyurethanes and particularly “Tecophilic” resins are available. The antimicrobial formulations may be compounded at about 300 to about 350° F., pelletized and extruded into a desired article, such as films or tubes.

### Outcome

Coating or the direct incorporation of the microbial formulation into the bulk of the plastic results in the formation of a surface that facilitates the slow release of antimicrobials to the surface. The silicone resin encapsulates the antimicrobial materials and releases them at a controlled rate. On exposure to aqueous fluids, such as various body fluids, the water soluble components of the antimicrobial formulation migrate to the surface, where an equilibrium is established between the silver, citric acid, and EDTA. This is important because silver ions are rendered insoluble due to the formation of silver chloride or phosphates in the presence of body fluids. The presence of EDTA, which complexes silver ions, forming soluble complexed species of silver, allows a continuous migration of these soluble species to the surface despite the presence of chloride ions. The presence of the other components of the formulation, such as parabens (para benzoic acid esters) and copper phthalocyanine, help to keep the surface of the coated article antimicrobial. The lubricant imparts a slippery feel when wetted with water; this property allows the insertion of the catheter without causing trauma to the patient. More importantly, the lubricant elutes continuously from the coating, keeping the surface hydrophilic and lubricious, thereby discouraging the adherence of bacteria.

### Extrusion of Articles with Antimicrobial Formulation Incorporation

Extrusion grade “Tecophilic” resin, such as HP-93A-100 ( Noveon) and the like, may be compounded with the antimicrobial formulation with the aid of an FDA approved carrier SPAN oil (a mixture of 70 wt % SPAN 85 (sorbtitan trioleate) and 30 wt % FDA approved white mineral oil, sold by Spectrum Chemicals). Separately, 800 gms of “Tecophilic”™ HP resin ( extrusion grade) is dried well as per manufacturer's instructions. SPAN oil at a level of about 1 to about 5 wt % with respect to the resin may be added with about 40 to about 50 gms of the antimicrobial material, about 30 to about 40 gms of sieved polyethylene oxide (PEO) and about 10 to about 30 gms of PEG 3350 (Spectrum Chemical) to impart lubricity and allow plasticization of the polymer.

### Compounding and Extrusion

When exposed to water and biological fluids, the extruded samples showed a water uptake of over 125% and showed about a 25% increase in dimensions. Because of the high affinity of the PEO for water, the swelling rate and extent in the presence of water is controlled by the amount of PEO or PEG depending on the application. (In general, additives such as polyethylene glycol or polyethylene oxide allow water to permeate into the polymer matrix thereby more easily releasing the antimicrobials.) The samples showed continuous biocidal activity and silver elution for at least 21 to 120 days in biological media such as ox bile (sold by Sigma) or artificial urine media depending on the concentration of the antimicrobial material.

### Coating or Dot-Matrix Adhesive on Woven Fabric

In a preferred embodiment of the invention, the coating formulations in non-aqueous solvents as prepolymers or full polymers are applied onto the backside of fabric. In a preferred manner of application of the coating material to woven fabrics doctor blade type coating to form a thin layer under the fabric is desirable. This layer would form physical barrier for microorganisms and also provide an active surface to kill the contacting microorganisms. The layer however, is highly moisture vapor permeable allowing sweat to escape with out causing heat stress to the wearer. There is a great need for protective fabrics to allow moisture (perspiration) to escape. If used as an adhesive the fabric may be bonded to another layer using the coating formulations form this invention.

### Description of Silicone Coating Formulations

In general, the adjustment of the concentration of the antimicrobial is achieved by changing the ratio of the antimicrobial formulation weight to the RTV weight (w/w %). Also, the RTV silicone/solvent ratio determines the viscosity and hence the coating weight. This is manipulated by varying the RTV/solvent (cyclohexane) w/w. This also dictates the coating weight and hence the amount of antimicrobial materials.

### Procedure for the Coating Formula for Silicone

Using a 200 mesh screen, suitable powder compositions from Example 1 may be sieved and dried in an oven at about 50° C. for 30 minutes. Polyethylene oxide powder is also sieved to 54 microns under dry conditions and dried in a desiccator. The mixture of the polyethylene oxide and the powder composition is slowly stirred into an appropriate amount of solvent such as cyclohexane. About 0.5% of “Tween 60” surfactant is added and stirred for an hour. An appropriate amount of RTV silicone is added and the solvent weight adjusted to the desired weight ratio and viscosity. Industrial or medical grade silicone such as “Silicone 40064” (from Applied) or “RTV Silicone” resin (from Dow) is stirred in at room temperature with a suitable amount of cyclohexane. A dispersion of fine particles in the silicone is obtained by this process.

Articles may be dipped into the above dispersion, preferably 1 to 3 times, each time drying the coating for at least 15 minutes at room temperature. The coatings may then be air-dried under ambient humid conditions overnight followed by further drying at 60° C. for 1 to 2 hours. The cure time varies depending upon the type of silicone used, but all become tack free with an hour.

Coating formula with silver citrate alone and the polyethylene oxide only (Formula C) may also be prepared to the desired percentage of silver or other antimicrobial materials in the total solids.

### Coating on Nonwoven Fabric

The nonwovens industry is challenged by the presence of microorganisms that are harbored by the porous materials. Respiratory masks such as the N95 grade (National Institute of Occupational Health and safety, NIOSH) provide only a passive barrier. The ability to make nonwovens resistant to microbial contamination has advantages in many applications and market segments. This is especially true in medical markets where nonwovens have already contributed a degree of aseptic sophistication beyond historically used linens.

The coated non-woven layers of this invention offer benefits, with no sacrifice to their efficacy, in air permeability and microorganism restriction. Antiseptic nonwoven barrier materials, one of which contains an antimicrobial agent, may be used in masks, drapes, and applications that require infection control.

The coating formulations from Example 1 are spray-coatable on such nonwovens and may be sandwiched between the passive layers. The method of drying is the same used for latex Foley catheters or polyurethane catheters.

### EXAMPLE 1

This example describes the ingredients of the various formulations from this invention.

### Formula A

The following formulation was prepared without titanium dioxide:

| | | |
|---|---|---|
| Silver citrate | 16.1 | wt % |
| Silver-copper | 8.0 | wt % |
| Citric acid | 16.0 | wt % |
| Propylparaben | 43 | wt % |
| EDTA | 16 | wt % |
| Copper phthalocyanine | 1 to 3 | wt % |

The ingredients were weighed and ground to a fine powder in an industrial blender. Prior to coating, 5 wt % polyethylene oxide (based on the weight of the RTV silicone resin to be added), was added to the powder and ground well. The composition was kept dry, in closed containers or in a low temperature oven.

### Formula B

A second formulation was prepared with titanium dioxide.

| Silver citrate | 10.5 | wt % |
|---|---|---|
| Silver-copper | 5.3 | wt % |
| Citric acid | 21.0 | wt % |
| Propyl paraben | 42 | wt % |
| EDTA | 10.5 | wt % |
| Copper phthalocyanine | 4.2% | |
| Titanium dioxide | 6.3 | wt % |

### Formula C

| | | |
|---|---|---|
| Silver citrate | 69.4 | gms |
| Nanosilver powder | 8.0 | gms, 150 nm (Inframat, PA) |
| Nanocopper | 1.6 | gms, 10-30 nm (Inframat, PA) |
| Propyl paraben | 5.0 | gms |
| Tetrasodium EDTA | 3 | gms |
| Citric acid | 1 | gms |
| Color enhancing pigment | 8 | gms |
| Coloring pigment | 2 | gms |

### Formula D

| | |
|---|---|
| Silver citrate | 50 gms |
| PEG 3350 (45-54 microns) | 16 gms |
| PEO (45-54 microns) | 32 gms |
| Copper phthalocyanine | 2 gms |

About 5-10% wt % sieved (45-54 microns) polyethylene oxide (based on the resin weight to be added), is added to the dispersion separately. Alternatively, the polyethylene oxide can be blended with the compositions under very dry conditions, preferably with the powder, prior to preparing the coating formula.

### EXAMPLE 2

This example illustrates the use of non-aqueous/aqueous mixtures of the polyurethanes mentioned in this invention for incorporating certain water based actives such as enzymes. An active enzyme was incorporated by using an aqueous form of the enzyme in a buffer and formulating with a plain “Tecophilic” resin in THF. Latex and other polyurethane tubes were coated. The enzyme activity was retained in such matrices.

### EXAMPLE 3

It was surprisingly found that hydrophilic polyurethane prepolymers, such as “Hypol 2002,” sold by Dow Chemical, could be blended with the antimicrobial compositions of this invention as a solvent-based paint-like formulation, such as in Examples 1 and 2, and coated on latex rubber substrates directly. The following powder composition was used:

| | |
|---|---|
| Silver citrate | 1.0 gms; 27.7 wt % (Sigma-Aldrich) |
| Silver powder | 0.4875 gms; 13.5 wt %, 1-2 microns |
| | (Advanced Materials, Conn, USA) |
| Copper nanopowder | 0.0125 gms; 0.3 wt % |
| | (Advanced Materials) |
| EDTA (diacid form) | 1.0 gms; 27.7 wt % |
| Propyl paraben | 1.0 gms; 27.7 wt % |
| Coloring pigment | 0.1 gms; 2.7 wt % |

The above composition was ground well and homogenized under dry conditions. The composition (1.2 gms) was dispersed into 10 gms of a dispersing solvent, methyl ethyl ketone (Sigma-Aldrich), stirred for 15 minutes and sonicated for 5 minutes. Then 2.5 gms of “Hypol 2002” was dissolved in 10 gms of MEK and the dispersion was added, followed by the addition of 1 gm of polyethylene oxide. The mixture was stirred for 15 minutes at room temperature. An additional 7.5 gms of “Hypol 2002” was dissolved in 5 gms of MEK and was added to the mixture and stirred well.

This formula had a thin paint-like consistency and was coatable. Latex tubes and pre-washed and thoroughly dried latex catheters (in a 1:1:1 isopropyl alcohol/water/toluene mixture by weight) were dip-coated directly into this mixture. The coatings were cured at room temperature using a trough of water underneath the drying catheters for humidification. Curing was complete in about 2 to 3 days at ambient room temperature or at 30° C. The typical coating weights were approximately 5 to 20% of the substrate weight depending on the number of dips.

The resulting product showed excellent lubricity, antimicrobial activity, adhesion to latex materials, and excellent stability against delaminating in biological media. Such coatings are suitable for gloves as well.

Water-borne polyurethanes, such as those sold by Cytec Industries (e.g., “Cydrothane HB 4033” or “Noveon Permax 120”) may also be blended with the powder formulations from this invention and applied on rubber or polymeric substrates primed with silane coupling agents such as amino alkyl silanes. In fact, water-borne polyurethanes containing the powder formulation from this invention without the polyethylene oxide (PEO) may also be used to coat latex substrates after priming the substrate with silanes or adhesion promoters such as the DuPont “Tyzor” or zirconium compounds.

Wider applications to multilayered configured materials with antimicrobial and protective properties are foreseen from this invention.

### EXAMPLE 4

Antiviral compounds may be incorporated into polymers, such as hydrophilic polyurethanes or silicone, for certain applications where antiviral activities are needed. It has been discovered by this inventor that bimidazole (two imidazole rings linked via c-c bond) by itself or in combination with sulfonates such as polyvinyl sulfonate or other sulfonate bearing groups is a potent antiviral. An HIV viral assay clearly showed the efficacy of the combination of biimidazole and polyvinyl sulfonate. The combination resulted in a white precipitate as the protonated biimidazole formed a ionic complex with the negatively charged sulfonate.

Bibenzimidazoles, bipyrazoles, bipyridyl pyrazines, tetrazines, bipyrimidines, and the like by themselves or in combination with sulfonate-bearing moieties are anticipated to be effective in this invention. Depending upon the product, one could selectively use antiviral releasing plastics such as intra-vaginal rings using these antivirals and in combination with antifungals.
Biimidazole was synthesized by the inventor using a method described in the literature referenced in U.S. Pat. No. 5,683,829 (1996).

The compound (0.5 gms) was protonated using dilute hydrochloric acid to a pH of 4 to a total volume of 30 ml. To 5 gms of this solution was added 5 gms of polyvinyl sulfonate (Aldrich, a 25 wt % aqueous solution). A white precipitate of the adduct immediately formed and remained colloidal without settling. This was used as such for an assay carried out by Imquest Bioscience, MD, and high dilutions were studied. The data showed that protonated biimidazole reacted with polyvinyl sulfonate and showed excellent efficacy and non-toxicity at very dilute concentrations (at the ppm level); the reduction of virus was 100% at concentrations where this combination was not toxic. This was very encouraging and showed high promise for HIV deactivation. These and other compounds could be incorporated into the polyurethane plastics of this invention for their slow delivery of antivirals; other viruses could be potentially also be deactivated.

1. An antimicrobial composition comprising
(I) about 5 to about 25 wt % of an antimicrobial formulation that comprises
(A) about 40 to about 60 wt % of an antimicrobial material;
(B) about 1 to about 55 wt % calcium chelator;
(C) about 0.001 to about 0.25 wt % pigment;
(D) about 0.5 to about 12 wt % lubricant;
(E) about 0.001 to about 3 wt % of color enhancing pigment; and
(F) about 0.001 to about 3 wt % of surfactant; and
(II) about 75 to about 95 wt % of a resin selected from the group consisting of polymers from the family of polyurethanes, polycarbonates, acrylates, nitrites, silicones, polyvinyl chloride, synthetic and natural rubber, styrene-butadiene rubber, and their copolymers and blends.

2. An antimicrobial composition according to claim 1 wherein said antimicrobial material is selected from the group consisting of silver, silver-copper mixtures, partially water soluble compounds of silver, silver pyrithione, zinc pyrithione, bismuth pyrithione, parabenzoic acid esters, percarbonate, perborate, urea-peroxide compounds, and mixtures thereof.

3. A antimicrobial composition according to claim 1 wherein said antimicrobial material is selected from biimidazoles, benzimidazoles, bibenzimidazoles, bipyrimidines, bipyrazines, tetrazines, mono- or bi-pyridyl pyridazines, derivatives thereof, or in combination with sulfonate and sulfate bearing compounds.

4. An antimicrobial composition according to claim 1 wherein said calcium chelator is citric acid, ethylene diamine tetraacetic acid, or a mixture thereof.

5. An antimicrobial composition according to claim 1 wherein said pigment is a mixture of about 0.1 to about 2 wt % copper phthalocyanine, FDA approved coloring pigments, and about 0.1 to about 3 wt % titania coated mica particles.

6. An antimicrobial composition according to claim 1 wherein said lubricant is a mixture of polyethylene oxide and polyethylene glycols.

7. An antimicrobial composition according to claim 1 wherein said surfactant is an ethylene glycol-propylene glycol block copolymer, a-polyoxyethylene sorbitan esters, a natural surfactants such as lecithins, natural oils, and bile salt surfactants.

8. An antimicrobial composition according to claim 1 that includes about 0.5 to about 4 wt % titanium dioxide.

9. An antimicrobial composition according to claim 1 wherein said polyurethane resin is an aqueous dispersion.

10. An antimicrobial composition according to claim 1 wherein said polyurethane resin is a non-aqueous dispersion.

11. An antimicrobial composition according to claim 1 wherein said polyurethane resin is a mixture of non-aqueous and aqueous media.

12. An antimicrobial composition according to claim 1 wherein said polyurethane resin is solid resin particles.

13. An antimicrobial composition according to claim 11 which includes about 0.5 to about 3 wt % of an adhesion promoter.

14. An antimicrobial composition according to claim 13 wherein said adhesion promoter is diisocyanoto hexane, an organometallic compound, or a metal oxide.

15. An antimicrobial composition according to claim 1 wherein said polyurethane resin is a prepolymer that polymerizes in the presence of moisture.

16. A method of forming an antimicrobial coating on the surface of an article comprising applying an antimicrobial composition according to claim 1 to said surface and permitting said solvent to evaporate.

17. A coated article made according to the method of claim 16.

18. A method of forming an antimicrobial coating on the surface of an article comprising applying an antimicrobial composition according to claim 1 to said surface and exposing said surface to moisture.

19. A method according to claim 16 wherein said article is made of a polymer, copolymer or blends or composites, natural latex rubber or synthetic rubber or metal and metal alloys.

20. A coated article made according to the method of claim 18.

21. A method according to claim 16 wherein said surface is a mandrel and, after said coating is formed, it is removed from said mandrel.

22. A method of forming an antimicrobial coating on the surface of an article comprising molding, overmolding, or extruding said article from an antimicrobial composition according to claim 1.

23. A method according to claim 21 wherein said polymeric resin is a solid or a dispersion in a solvent.

24. A coated article made according to the method of claim 21.

25. An antimicrobial composition comprising
(I) about 5 to about 25 wt % of an antimicrobial formulation that comprises
(A) about 15 to about 25 wt % of silver, silver-copper mixture, a partially water soluble silver salt, or mixtures thereof and about 25 to about 45 wt % of parabenzoic acid esters;
(B) about 20 to about 25 wt % citric acid and about 20 to
